(19) United States
(12) Patent Application Publication
(10) Pub. No.: US 2026/0291114 A1
(43) Pub. Date: Sep. 24, 2026

(54) DATA CABLE AND ELECTRONIC DEVICE

(71) Applicant: Dongguan Xinganhui Electronic Technology Co., Ltd., Dongguan (CN)

(72) Inventor: Wangsheng Chen, Dongguan (CN)

(21) Appl. No.: 19/686,856

(22) Filed: May 25, 2026

(30) Foreign Application Priority Data
Apr. 8, 2026 (CN) 202620467671.7

(51) Int. Cl. H01R 13/502

(52) U.S. Cl. CPC H01R 13/502

(57) ABSTRACT

A data cable and an electronic device are provided. The cable includes a terminal and a connection cable. At least one end of the connection cable is provided with the terminal. The terminal includes a terminal head and a rotation module sleeved on the terminal head. A plug-in port is disposed on the terminal head. The plug-in port is electrically connected to the connection cable. The rotation module includes a rotating member and a housing assembly. The housing assembly is sleeved on the terminal head. The rotating member is rotatably sleeved on the housing assembly. A bearing is sleeved on the housing assembly. An inner race of the bearing is connected to the housing assembly. An outer race of the bearing is connected to the rotating member.

### TECHNICAL FIELD

The present disclosure relates to the technical field of electronic accessories, and in particular to a data cable and an electronic device.

### BACKGROUND

In recent years, conventional data cables on the market only provide charging and data transmission functions. The conventional data cables have a single function and a lack of interest, and lack decompressing and relaxing interaction modes in scenarios such as charging waiting and office leisure. Some users are accustomed to playing with small objects, but the conventional data cables cannot meet requirements such as decompression, entertainment, and anxiety relief. Product experience and added values are low.

### SUMMARY

To solve a technical problem that a data cable is single in function and has a lack of interest, the present disclosure provides a data cable and an electronic device.

The solution adopted by the present disclosure to solve the technical problem is to provide a data cable, including a terminal and a connection cable, where at least one end of the connection cable is provided with the terminal; the terminal includes a terminal head and a rotation module sleeved on the terminal head; a plug-in port is disposed on the terminal head; the plug-in port is electrically connected to the connection cable; the rotation module includes a rotating member and a housing assembly; the housing assembly is sleeved on the terminal head; the rotating member is rotatably sleeved on the housing assembly; a bearing is sleeved on the housing assembly; an inner race of the bearing is connected to the housing assembly; and an outer race of the bearing is connected to the rotating member.

Preferably, the rotation module further includes a limiter, where the limiter is sleeved on the connection cable; a mounting groove is disposed at one end of the rotating member, and the limiter is partially disposed inside the mounting groove; and the limiter abuts against the rotating member by abutting against the mounting groove.

Preferably, a limit boss is disposed on an inner surface of the rotating member; the limit boss cooperates with the bearing; and the bearing is disposed between the terminal head and the limit boss.

Preferably, the housing assembly is sleeved at a joint between the terminal head and the connection cable, and the plug-in port is exposed outside the housing assembly.

Preferably, a first boss is disposed on the housing assembly, and the limiter cooperates with the first boss.

Preferably, the housing assembly includes a fixed housing and a sliding housing, and the fixed housing is sleeved on the terminal head; the rotating member is disposed on the sliding housing, and a sliding rail is disposed on the fixed housing along a length direction of the terminal head; and a sliding member is disposed on the sliding housing corresponding to the sliding rail, and the sliding member is slidably connected to the sliding rail.

Preferably, an accommodating groove is provided on an end portion that is of the housing assembly and that is close to the plug-in port; the accommodating groove cooperates with the plug-in port; and the housing assembly completely covers the plug-in port.

Preferably, a protective sleeve is disposed between the fixed housing and the terminal head; and the protective sleeve completely covers a joint between the terminal head and the data cable.

Preferably, the housing assembly is provided with a second boss, a third boss, and a limit bolt, and the second boss and the third boss are disposed coaxially; the bearing is disposed on the third boss; and the limit bolt cooperates with the second boss through the mounting groove.

The present disclosure further provides an electronic device, including the data cable.

Compared with the prior art, a data cable and an electronic device provided by the present disclosure have the following advantages.
1. Embodiments of the present disclosure provide a data cable. A rotation module is disposed on a terminal, so that the data cable has decompressing and relaxing interaction functions. The rotation module including the rotating member and the housing assembly is disposed on the terminal head, and the bearing structure is introduced, so that the inner race of the bearing is fixedly connected to the housing assembly, and the outer race of the bearing is fixedly connected to the rotating member. With this design, sliding friction of a contact surface is converted into rolling friction supported by the bearing, which reduces rotation resistance. A user only needs to gently toggle the rotating member, and the rotating member can rotate smoothly and durably on the terminal head. This provides the user with a visual and tactile decompression method during fragmented time for office work or charging waiting, thereby enhancing interestingness of a product.
2. In the data cable provided in the embodiments of the present disclosure, coordination between the limiter and the mounting groove plays an axial positioning role on the rotating member, so as to prevent axial movement of the rotating member in a rotation process, and ensure that when the user plays with the rotating member at high frequency and long duration, the entire rotation module is always locked in a preset axial range. This stable structural design avoids component detachment due to excessive force, thereby ensuring durability of the rotation module.
3. In the data cable provided in the embodiments of the present disclosure, the limit boss on the inner surface of the rotating member and the bearing are physically limited, which provides stable radial and axial support for the bearing in a complex dynamic environment. Radial shaking during rotation of the rotating member is eliminated. This assembly effect provides the user with a smooth rotation touch, thereby avoiding a cheap mechanical friction sense, and relieving anxiety of the user from tactile feedback.
4. In the data cable provided in the embodiments of the present disclosure, a housing assembly is sleeved at the joint between the terminal head and the connection cable, thereby forming a solid physical barrier and enhancing a bending resistance capability of this area. In addition, the plug-in port is kept exposed outside the housing assembly, so that the user can rotate and play with the data cable without unplugging the data cable. This design implements parallel experience of decompressing while charging, and an original boring charging process is converted into interesting interaction time.
5. In the data cable provided in the embodiments of the present disclosure, a set of overall locking mechanisms is constructed by disposing the first boss on the housing assembly and implementing mechanical cooperation with the limiter. This structure is designed specifically for frequent play scenarios, and can effectively prevent the rotation module from loosening under long-term rotation, pulling, or stress impact, thereby ensuring long-term reliability of an entire rotation architecture.
6. In the data cable provided in the embodiments of the present disclosure, this structure implements detachable fixation of the rotation module on the terminal head by using the sliding rail on a fixed housing and the sliding member on the sliding housing. The fixed housing serves as a stable base to ensure a connection with the terminal head, but a linear moving logic of the sliding member along the sliding rail enables the user to demount the rotation module integrally when needing charging, and the rotation module is fixed to one side to implement side accommodation by using the sliding rail structure. This design not only increases interest of mechanical disassembly, but also avoids a problem that the module is prone to lose after disassembly, thereby implementing that functionality and a play value are highly integrated.
7. In the data cable provided in the embodiments of the present disclosure, by using the accommodating groove at a front end of the housing assembly, the rotation module may completely wrap the plug-in port. This structure implements dust prevention, moisture prevention, and anti-oxidation protection at a physical level, thereby solving a problem of poor contact caused by long-term exposure of an interface of a conventional data cable.
8. In the data cable provided in the embodiments of the present disclosure, the protective sleeve is nested between the fixed housing and the terminal head, and full coverage is implemented at the joint between the terminal head and the data cable. The protective sleeve is usually made of a flexible material, and can effectively disperse stress concentration points during bending, thereby solving the most common pain points of sheath damage and wire breakage of the data cable, and improving product reliability.
9. In the data cable provided in the embodiments of the present disclosure, a set of high-strength fastening loops is formed by using a coaxial step design of the second boss, the third boss, and the bearing and combing the limit bolt that runs through the mounting groove and is locked to the second boss. This structure ensures that complex multi-component modules do not cause looseness, abnormal noise, or disassembly during long-term and high-frequency use, thereby improving durability of overall hardware.
10. The embodiments of the present disclosure further provide an electronic device, and the electronic device is configured with a data cable with a decompression attribute. Through a series of innovative interactions such as rotary decompression, side storage, and modular disassembly, anxiety of modern users in a device use process is effectively alleviated, and brand differentiation competitiveness of the electronic device is greatly improved.

### BRIEF DESCRIPTION OF THE DRAWINGS

In order to illustrate technical solutions in the embodiment of the present disclosure more clearly, drawings needing to be used in the embodiment or in the description in the prior art are simply described. Apparently, the embodiments in the following description are merely a part rather than all of the embodiments of the present disclosure. For any person skilled in the art, under the premise of without contributing creative labor, other drawings further can be obtained based on these drawings.

FIG. 1 is a schematic diagram of a data cable according to an embodiment of the present disclosure;

FIG. 2 is an exploded view of a data cable in Embodiment 1 according to an embodiment of the present disclosure;

FIG. 3 is a section view of a data cable in Embodiment 1 according to an embodiment of the present disclosure;

FIG. 4 is an exploded view of a data cable in Embodiment 2 according to an embodiment of the present disclosure;

FIG. 5 is a section view of a data cable in Embodiment 2 according to an embodiment of the present disclosure;

FIG. 6 is a schematic diagram of a rotation state of a data cable in Embodiment 2 according to an embodiment of the present disclosure; and

FIG. 7 is a schematic diagram of an electronic device according to an embodiment of the present disclosure.

Reference numerals in the drawings:
10: data cable; 20: electronic device;
1: terminal; 11: rotation module; 111: rotating member; 1111: limit boss; 1112: mounting groove; 112: housing assembly; 1121: fixed housing; 11211: sliding rail; 1122: sliding housing; 11221: sliding member; 11222: plug-in connector; 1123: first boss; 11231: external thread; 1124: second boss; 1125: third boss; 1126: accommodating groove; 113: limiter; 114: limit bolt; 115: bearing; 12: terminal head; 13: plug-in port; 114: protective sleeve; and
2: connection cable.

### DETAILED DESCRIPTION OF THE EMBODIMENTS

In order to make the objectives, technical solutions and advantages of the present disclosure clearer, the present disclosure will be further described hereinbelow with reference to the drawings and embodiments thereof. It should be understood that, the embodiments described herein are only intended to illustrate but not to limit the present disclosure.

It needs to be noted that in the specification and claims of the present disclosure, the terms such as “first” and “second” are intended to distinguish between different objects but do not necessarily indicate a specific order.

What needs illustration is that when one component is referred to as being “fixed” on the other component, the component can be directly arranged on the other element or an intermediate component can exist. When one component is referred to as being “connected” to the other component, the component can be directly connected to the other component or an intermediate component exists possibly at the same time. As used herein, the terms “vertical,” “horizontal,” “left,” “right,” and similar expressions are used for illustrative purposes only.

In the present disclosure, the azimuths or positional relationships indicated by the terms “upper”, “lower”, “left”, “right”, “front”, “back”, “top”, “bottom”, “inside”, “outside”, “middle”, “vertical”, “horizontal”, “transverse”, and “longitudinal” are based on azimuths or positional relationships shown in the drawings. The terms are mainly used for facilitating the description and embodiments of the present disclosure, but not for indicating or hinting that the indicated device or element must be in a specific direction and is constructed and operated in the specific direction.

Also, besides direction or position relations, some of the terms above may be used to refer to other meanings, for example, the term “on” may also be used to refer to some kind of dependency or connection relationship in some cases. For those skilled in the art, the specific meanings of the terms in the present disclosure can be understood according to specific conditions.

Moreover, the terms “installed”, “arranged”, “provided”, and “connected” should be understood broadly. For example, the connection may be fixed connection, detachable connection or integral construction; the connection may be mechanical connection or electrical connection; and the connection may be direct connection, or indirect connection through an intermediate, or internal communication between two devices, elements or components. For those skilled in the art, the specific meanings of the terms in the present disclosure can be understood according to specific conditions.

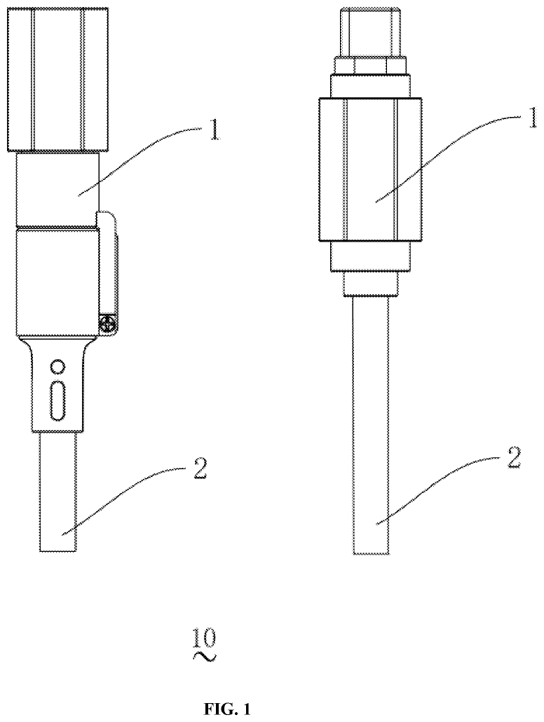

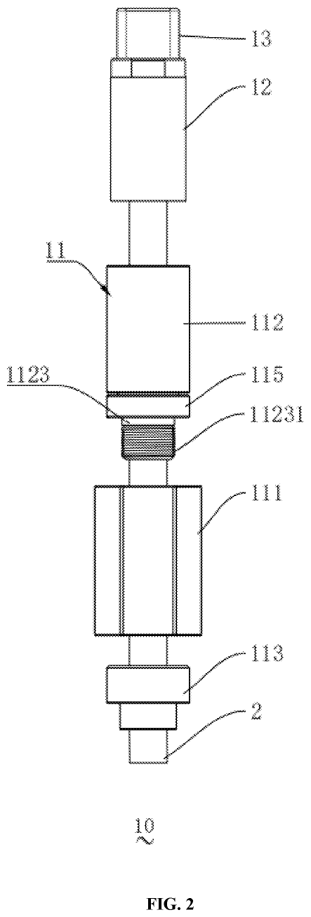

Referring to FIG. 1 and FIG. 2, embodiments of the present disclosure provide a data cable 10, including a terminal 1 and a connection cable 2. At least one end of the connection cable 2 is provided with the terminal 1. The terminal 1 includes a terminal head 12 and a rotation module 11 sleeved on the terminal head 12. A plug-in port 13 is disposed on the terminal head 12. The plug-in port 13 is electrically connected to the connection cable 2. The rotation module 11 includes a rotating member 111 and a housing assembly 112. The housing assembly 112 is sleeved on the terminal head 12. The rotating member 111 is rotatably sleeved on the housing assembly 112. A bearing 115 is sleeved on the housing assembly 112. An inner race of the bearing 115 is connected to the housing assembly 112. An outer race of the bearing 115 is connected to the rotating member 111.

It may be understood that the embodiments of the present disclosure provide a data cable 10. A rotation module 11 is disposed on a terminal 1, so that the data cable 10 has decompressing and relaxing interaction functions. The rotation module 11 including a rotating member 111 and a housing assembly 112 is disposed on a terminal head 12, and a bearing 115 structure is introduced, so that an inner race of the bearing 115 is fixedly connected to the housing assembly 112, and an outer race of the bearing 115 is fixedly connected to the rotating member 111. With this design, sliding friction of a contact surface is converted into rolling friction supported by the bearing 115, which reduces rotation resistance. A user only needs to gently toggle the rotating member 111, and the rotating member can rotate smoothly and durably on the terminal head 12. This provides the user with a visual and tactile decompression method during fragmented time for office work or charging waiting, thereby enhancing interestingness of a product.

Specifically, an outer ring of the rotating member 111 is provided with a patterned or non-cylindrical structure.

It may be understood that a patterned or prismatic structure is disposed on an outer ring of the rotating member 111, thereby increasing a friction coefficient between a finger and a surface of the rotating member 111. During actual plugging and unplugging of the data cable 10, the patterned or prismatic structure also serves as a non-slip grip. When the rotating member 111 rotates, the patterned or prismatic structure on the outer ring may form a unique light shadow circle or a dynamic pattern based on a visual transient effect, thereby enhancing a dynamic aesthetic sense of the product.

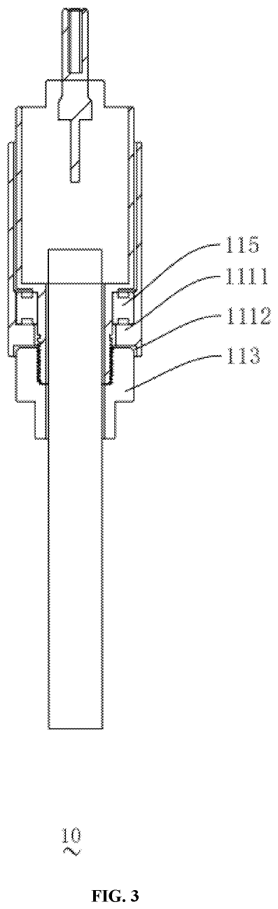

Referring to FIG. 2 and FIG. 3, the rotation module 11 further includes a limiter 113. The limiter 113 is sleeved on the connection cable 2. A mounting groove 1112 is disposed at one end of the rotating member 111, and the limiter 113 is partially disposed inside the mounting groove 1112. The limiter 113 abuts against the rotating member 111 by abutting against the mounting groove 1112.

It may be understood that, in the data cable 10 provided in the embodiments of the present disclosure, coordination between the limiter 113 and the mounting groove 1112 plays an axial positioning role on the rotating member 111, so as to prevent axial movement of the rotating member 111 in a rotation process, and ensure that when the user plays with the rotating member 111 at high frequency and long duration, the entire rotation module 11 is always locked in a preset axial range. This stable structural design avoids component detachment due to excessive force, thereby ensuring durability of the rotation module 11.

Referring to FIG. 2 and FIG. 3, a first boss 1123 is disposed on the housing assembly 112, and the limiter 113 cooperates with the first boss 1123.

It may be understood that, in the data cable 10 provided in the embodiments of the present disclosure, the first boss 1123 is disposed on the housing assembly 112 to implement mechanical cooperation with the limiter 113, thereby establishing a set of overall locking mechanisms. This structure is designed specifically for frequent play scenarios, and can effectively prevent the rotation module 11 from loosening under long-term rotation, pulling, or stress impact, thereby ensuring long-term reliability of an entire rotation architecture.

Specifically, an external thread 11231 is disposed on the first boss 1123; and the first boss 1123 cooperates with the limiter 113 by using a hollow position of the accommodating groove 1126.

It may be understood that the external thread 11231 is disposed on the first boss 1123, so that the external thread passes through the hollow position of the accommodating groove 1126 to implement thread locking with the limiter 113, and a rigid connection architecture is constructed. A threaded connection has axial tensile strength and self-locking capability, and can effectively cope with pulling, impact and vibration generated by the user in a high-frequency decompressing and playing process, thereby preventing the rotation module 11 from loosening or falling off, and improving structural reliability of the product.

Referring to FIG. 2 and FIG. 3, a limit boss 1111 is disposed on an inner surface of the rotating member 111; the limit boss 1111 cooperates with the bearing 115; and the bearing 115 is disposed between the terminal head 12 and the limit boss 1111.

It may be understood that, in the data cable 10 provided in the embodiments of the present disclosure, the limit boss 1111 on the inner surface of the rotating member 111 is used to physically limit the bearing 115, which provides stable radial and axial support for the bearing 115 in a complex dynamic environment. Radial shaking during rotation of the rotating member 111 is eliminated. This assembly effect provides the user with a smooth rotation touch, thereby avoiding a mechanical friction sense, and relieving anxiety of the user from tactile feedback.

Referring to FIG. 2, the housing assembly 112 is sleeved at a joint between the terminal head 12 and the connection cable 2, and the plug-in port 13 is exposed outside the housing assembly 112.

It may be understood that, in the data cable 10 provided in the embodiments of the present disclosure, the housing assembly 112 is sleeved at the joint between the terminal head 12 and the connection cable 2, thereby forming a solid physical barrier and enhancing a bending resistance capability of this area. In addition, the plug-in port 13 is kept exposed outside the housing assembly 112, so that the user can rotate and play with the data cable without unplugging the data cable 10. This design implements parallel experience of decompressing while charging, and an original boring charging process is converted into interesting interaction time.

A second embodiment of the present disclosure provides another arrangement manner of the data cable 10. In actual application, one of two arrangement manners is selected.

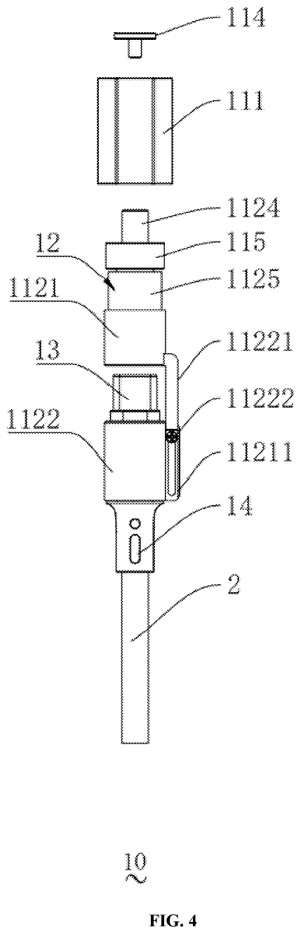

Referring to FIG. 4, the housing assembly 112 includes a fixed housing 1121 and a sliding housing 1122, and the fixed housing 1121 is sleeved on the terminal head 12. The rotating member 111 is disposed on the sliding housing 1122, and a sliding rail 11211 is disposed on the fixed housing 1121 along a length direction of the terminal head 12. A sliding member 11221 is disposed on the sliding housing 1122 corresponding to the sliding rail 11211, and the sliding member 11221 is slidably connected to the sliding rail 11211.

It may be understood that, in the data cable 10 provided in the embodiments of the present disclosure, this structure implements detachable fixation of the rotation module 11 on the terminal head 12 by using the sliding rail 11211 on the fixed housing 1121 and the sliding member 11221 on the sliding housing 1122. The fixed housing 1121 serves as a stable base to ensure a connection with the terminal head 12, but a linear moving logic of the sliding member 11221 along the sliding rail 11211 enables the user to demount the rotation module 11 integrally when needing charging, and the rotation module is fixed to one side to implement side accommodation by using the sliding rail 11211 structure. This design not only increases interest of mechanical disassembly, but also avoids a problem that the module is prone to lose after disassembly, thereby implementing that functionality and a play value are highly integrated.

Specifically, a plug-in connector 11222 is disposed on the sliding member 11221, and the plug-in connector 11222 passes through the sliding rail 11211 to cooperate with closed positions two ends of the sliding rail 11211.

It may be understood that the plug-in connector 11222 that passes through the sliding rail 11211 is disposed on the sliding member 11221, and a mechanical limit cooperation is formed between the plug-in connector and closed parts at two ends of the sliding rail 11211, so as to construct a specific physical boundary for linear displacement of the rotation module 11. This design effectively prevents the sliding housing 1122 from being detached from the fixed housing 1121 due to excessive force during frequent push-pull playing, thereby ensuring integrity and safety of an overall structure, simulating a segment sense of a mechanical switch, and greatly enhancing interestingness and a decompression attribute of push-pull interaction. This penetrating plug-in structure also plays a role of a reinforcing rib, thereby ensuring structural stability under long-term use.

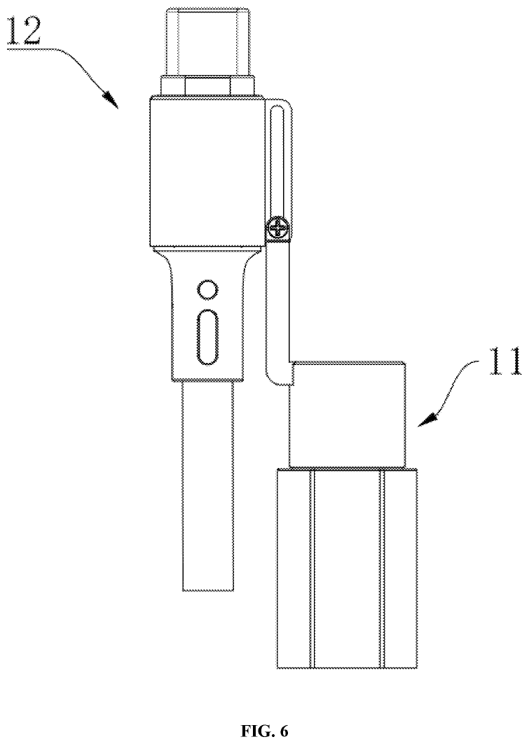

Referring to FIG. 1, FIG. 4, and FIG. 6, the sliding housing 1122 may rotate around the plug-in connector 11222.

It may be understood that, the plug-in connector that passes through the sliding rail is disposed on the sliding member, and the sliding housing can rotate around the plug-in connector, thereby implementing a multi-degree-of-freedom compound motion mechanism of linear sliding flip. This design gives the sliding housing a multi-angle swing capability. In actual application, the user may not only push and pull the sliding housing back and forth, but also rotate the sliding housing around the plug-in connector to a side, thereby avoiding interference of the sliding housing to a plug-in space during charging. A dynamic hand sense of the product is enriched, and multi-dimensional mechanical playing experience is implemented, thereby improving interesting and functional flexibility of the product.

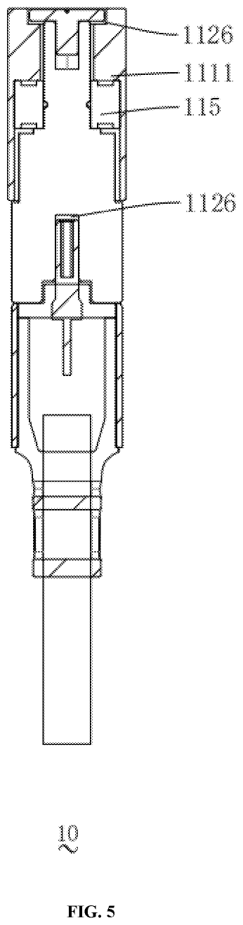

Referring to FIG. 4 and FIG. 5, an accommodating groove 1126 is provided on an end portion that is of the housing assembly 112 and that is close to the plug-in port 13; the accommodating groove 1126 cooperates with the plug-in port 13; and the housing assembly 112 completely covers the plug-in port 13.

It may be understood that, in the data cable 10 provided in the embodiments of the present disclosure, by using the accommodating groove 1126 at a front end of the housing assembly 112, the rotation module 11 may completely wrap the plug-in port 13. This structure implements dust prevention, moisture prevention, and anti-oxidation protection at a physical level, thereby solving a problem of poor contact caused by long-term exposure of an interface of a conventional data cable 10.

Referring to FIG. 4, a protective sleeve 14 is disposed between the fixed housing 1121 and terminal head 12; and the protective sleeve 14 completely covers the joint between the terminal head 12 and data cable 10.

It may be understood that, in the data cable 10 provided in the embodiments of the present disclosure, the protective sleeve 14 is nested between the fixed housing 1121 and the terminal head 12, and full coverage is implemented at the joint between the terminal head 12 and the data cable 10. The protective sleeve 14 is usually made of a flexible material, and can effectively disperse stress concentration points during bending, thereby solving the most common pain points of sheath damage and wire breakage of the data cable 10, and improving product reliability.

Referring to FIG. 4 and FIG. 5, the housing assembly 112 is provided with a second boss 1124, a third boss 1125, and a limit bolt 114, and the second boss 1124 and the third boss 1125 are disposed coaxially; the bearing 115 is disposed on the third boss 1125; and the limit bolt 114 cooperates with the second boss 1124 through the mounting groove 1112.

It may be understood that, in the data cable 10 provided in the embodiments of the present disclosure, a set of high-strength fastening loops is formed by using a coaxial step design of the second boss 1124, the third boss 1125, and the bearing 115 and combing the limit bolt 114 that runs through the mounting groove 1112 and is locked to the second boss 1124. This structure ensures that complex multi-component modules do not cause looseness, abnormal noise, or disassembly during long-term and high-frequency use, thereby improving durability of overall hardware.

It needs to be noted that, in a second embodiment of the present disclosure, the limit boss 1111 of the rotating member 111 cooperates with the third boss 1125 to implement limit; the inner race of the bearing 115 is connected to the second boss 1124; and the outer race of the bearing 115 is connected to the rotating member 111.

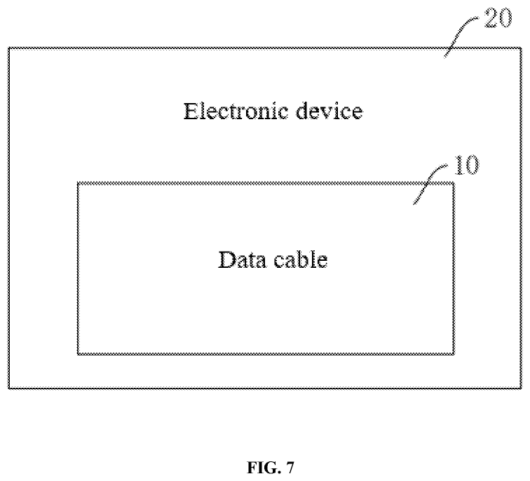

Referring to FIG. 7, a third embodiment of the present disclosure provides an electronic device 20, including the data cable 10.

It may be understood that, the embodiments of the present disclosure further provide an electronic device 20, and the electronic device 20 is configured with a data cable 10 with a decompression attribute. Through a series of innovative interactions such as rotary decompression, side storage, and modular disassembly, anxiety of modern users in a device use process is effectively alleviated, and brand differentiation competitiveness of the electronic device 20 is greatly improved.

It should be noted that, the electronic device may be a power bank, a smart phone, a flat computer, a notebook computer, and other devices.

It should be noted that the terminals 1 are disposed at both ends of the data cable 10, and terminals 1 at both ends respectively use housing solutions provided in the first embodiment and the second embodiment.

The foregoing descriptions are merely exemplary embodiments of the present disclosure, but are not intended to limit the present disclosure. Any modification, equivalent replacement, improvement, and the like made within the principle of the present disclosure shall fall within the protection scope of the present disclosure.

What is claimed is:

1. A data cable, comprising a terminal and a connection cable, wherein at least one end of the connection cable is provided with the terminal; the terminal comprises a terminal head and a rotation module sleeved on the terminal head; a plug-in port is disposed on the terminal head; the plug-in port is electrically connected to the connection cable; the rotation module comprises a rotating member and a housing assembly; the housing assembly is sleeved on the terminal head; the rotating member is rotatably sleeved on the housing assembly; a bearing is sleeved on the housing assembly; an inner race of the bearing is connected to the housing assembly; and an outer race of the bearing is connected to the rotating member.

2. The data cable according to claim 1, wherein the rotation module further comprises a limiter, wherein the limiter is sleeved on the connection cable; a mounting groove is disposed at one end of the rotating member, and the limiter is partially disposed inside the mounting groove; and the limiter abuts against the rotating member by abutting against the mounting groove.

3. The data cable according to claim 1, wherein a limit boss is disposed on an inner surface of the rotating member; the limit boss cooperates with the bearing; and the bearing is disposed between the terminal head and the limit boss.

4. The data cable according to claim 3, wherein the housing assembly is sleeved at a joint between the terminal head and the connection cable, and the plug-in port is exposed outside the housing assembly.

5. The data cable according to claim 2, wherein a first boss is disposed on the housing assembly, and the limiter cooperates with the first boss.

6. The data cable according to claim 1, wherein the housing assembly comprises a fixed housing and a sliding housing, and the fixed housing is sleeved on the terminal head; the rotating member is disposed on the sliding housing, and a sliding rail is disposed on the fixed housing along a length direction of the terminal head; and a sliding member is disposed on the sliding housing corresponding to the sliding rail, and the sliding member is slidably connected to the sliding rail.

7. The data cable according to claim 3, wherein an accommodating groove is provided on an end portion that is of the housing assembly and that is close to the plug-in port; the accommodating groove cooperates with the plug-in port; and the housing assembly completely covers the plug-in port.

8. The data cable according to claim 6, wherein a protective sleeve is disposed between the fixed housing and the terminal head; and the protective sleeve completely covers a joint between the terminal head and the data cable.

9. The data cable according to claim 2, wherein the housing assembly is provided with a second boss, a third boss, and a limit bolt, and the second boss and the third boss are disposed coaxially; the bearing is disposed on the third boss; and the limit bolt cooperates with the second boss through the mounting groove.

10. An electronic device, comprising the data cable according to claim 1.
